(19) United States
(12) Patent Application Publication
(10) Pub. No.: US 2021/0073016 A1
(43) Pub. Date: Mar. 11, 2021

(54) SECURE TRUSTED SHARED RENDERING

(71) Applicant: PAYPAL, INC., San Jose, CA (US)

(72) Inventor: Derek Michael Anderson, Yankton, SD (US)

(21) Appl. No.: 16/563,890

(22) Filed: Sep. 8, 2019

(51) Int. Cl. G06F 9/455; G06F 16/958; G06F 16/957

(52) U.S. Cl. CPC G06F 9/45529; G06F 9/4552; G06F 16/957; G06F 16/958; G06F 9/45545

(57) ABSTRACT

A system and method for providing secured trusted shared rendering are described. A sandbox environment is provided for a third-party guest app. Code for the third-party guest app is loaded into the sandbox environment. The code is executed in an abstraction layer. Messages generated by the execution of the code is relayed to a guard. By relaying the messages to the guard, a rendering of a user interface that includes a third-party guest app integrated within a host webpage is caused.

### TECHNICAL FIELD

The subject technology generally relates to integrating a multi-platform environment and more particularly, relates to a system and method for providing a secure trusted shared rendering of user elements.

### BACKGROUND

That integration of third-parties (internal or external to an organization) into a multi-platform environment such as web, iOS and Android poses many challenges. Developers generally have to choose between providing enhanced security or elevating user experiences when building apps to run in these environments. For example, webpages or apps owned by one organization may provide a portal for a third-party to incorporate another app within the original. In order to maintain adequate security, these portals are rigidly structured with little flexibility for the third-party to enhance the integration. In other words, the app within the webpage/app may appear disjointed in some instances and thus may provide an undesirable user experience. As such, there needs to be a solution that provides not only a better platform for shared rendering, but also maintains an adequate amount of security.

### SUMMARY

According to various aspects of the subject technology, a system for providing secured trusted shared rendering is described. A sandbox environment is provided for a third-party guest app. Code for the third-party guest app is loaded into the sandbox environment. The code is executed in an abstraction layer. Messages generated by the execution of the code is relayed to a guard. By relaying the messages to the guard, a rendering of a user interface that includes a third-party guest app integrated within a host webpage is caused.

According to various aspects of the subject technology, a method for providing secured trusted shared rendering is provided. A sandbox environment is provided for a third-party guest app. Code for the third-party guest app is loaded into the sandbox environment. The code is executed in an abstraction layer. Messages generated by the execution of the code is relayed to a guard. By relaying the messages to the guard, a rendering of a user interface that includes a third-party guest app integrated within a host webpage is caused.

According to various aspects of the subject technology, a non-transitory machine-readable medium having stored thereon machine-readable instructions executable for providing secured trusted shared rendering is provided. A sandbox environment is provided for a third-party guest app. Code for the third-party guest app is loaded into the sandbox environment. The code is executed in an abstraction layer. Messages generated by the execution of the code is relayed to a guard. By relaying the messages to the guard, a rendering of a user interface that includes a third-party guest app integrated within a host webpage is caused.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 is a block diagram of an exemplary computing system on which the provisioning of secured trusted shared rendering may be performed.

FIG. 2 is a block diagram of an exemplary computer system suitable for implementing one or more devices of the computing system in FIG. 1.

FIG. 3a illustrates an example layout that incorporates a guest content on a host webpage using inline frames (iFrames).

FIG. 3b illustrates an example layout that incorporates a guest content on a host webpage using secured trusted shared rendering.

FIG. 4 provides an exemplary process 400 for providing secured trusted shared rendering.

### DETAILED DESCRIPTION

Currently, most third-party trusted shared user experiences are run through iFrames. The use of iFrames, however, often results in certain rendering boundaries. For example, iFrames may be limited in size and dimension, thereby forcing third-party apps to be tailored to fit within these limits. Additionally, because the third-party application is integrated within the iFrame, certain functionalities may be clunky. For example, navigations buttons within the frame my not function in the same manner as they would in a native app or browser. Also, directly linking pages other than the initial iFrame uniform resource locator (URL) may be difficult. Additionally, the size of the content displayed within an iFrame may be unpredictable, and thus, may produce a need for a scroll bar that further detracts from the user's experience.

The proposed solution bridges the gap between the host organization and the third-party guest by serializing the communication between the host and guest. Doing so allows for a set of defined approved user interface (UI) elements and user actions (button clicks, animations, etc.) to be shared. Another benefit of the solution is that it maintains some separation between the guest apps and the host such that the guest apps aren't able to execute code within the main window or main application container. The guest app also will not have access to cookie information, unless access is otherwise granted.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal, etc.). Furthermore, various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

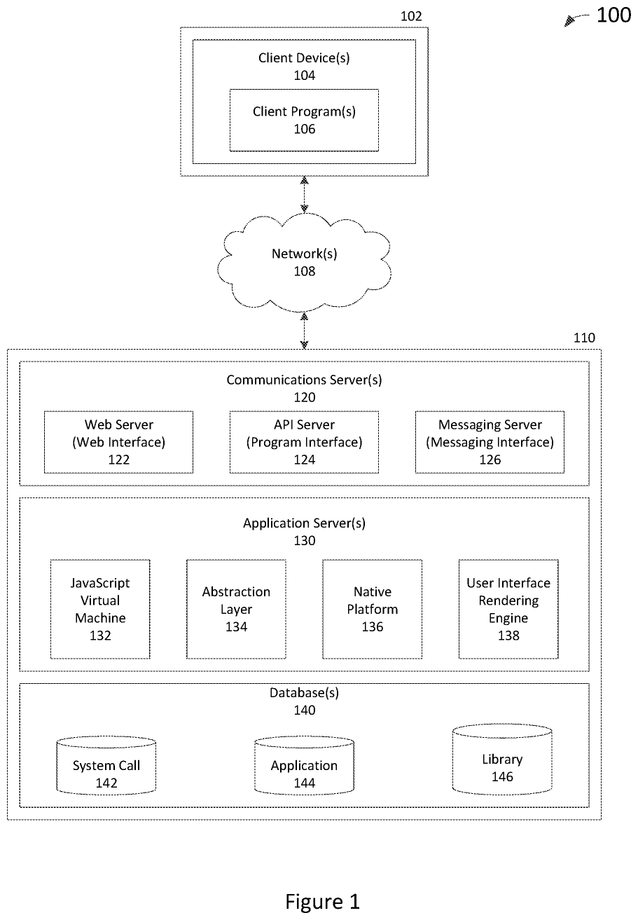

FIG. 1 is a block diagram of an exemplary computing system on which the provision of secured trusted shared rendering may be performed. As shown, a computing system 100 may comprise or implement a plurality of servers, devices, and/or software components that operate to perform various methodologies in accordance with the described embodiments. Exemplary servers, devices, and/or software components may include, for example, stand-alone and enterprise-class servers running an operating system (OS) such as a MICROSOFT® OS, a UNIX® OS, a LINUX® OS, or other suitable OS. It may be appreciated that the servers illustrated in FIG. 1 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Computing system 100 may include, among various devices, servers, databases and other elements, one or more clients 102 comprising or employing one or more client devices 104, such as a laptop, a mobile computing device, a tablet, a personal computer, a wearable device, and/or any other computing device having computing and/or communications capabilities in accordance with the described embodiments. Client devices 104 may also include a cellular telephone, smart phone, electronic wearable device (e.g., smart watch, virtual reality headset), or other similar mobile devices that a user may carry on or about his or her person and access readily.

Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, iOS, Android, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a payment system application, a web browser application, messaging application, contacts application, calendar application, electronic document application, database application, media application (e.g., music, video, television), location-based services (LBS) application (e.g., GPS, mapping, directions, positioning systems, geolocation, point-of-interest, locator) that may utilize hardware components such as an antenna, and so forth. One or more of client programs 106 may display various graphical user interfaces (GUIs) to present information to and/or receive information from one or more users of client devices 104. In some embodiments, client programs 106 may include one or more applications configured to conduct some or all of the functionalities and/or processes discussed below.

As shown, client devices 104 may be communicatively coupled via one or more networks 108 to a network-based system 110. Network-based system 110 may be structured, arranged, and/or configured to allow client 102 to establish one or more communications sessions between network-based system 110 and various client devices 104 and/or client programs 106. Accordingly, a communications session between client devices 104 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data communications between client devices 104 and the network-based system 110 may be sent and received over one or more networks 108 such as the Internet, a WAN, a WWAN, a WLAN, a mobile telephone network, a landline telephone network, personal area network, as well as other suitable networks. For example, client devices 104 may communicate with network-based system 110 over the Internet or other suitable WAN by sending and or receiving information via interaction with a website, e-mail, IM session, and/or video messaging session. Any of a wide variety of suitable communication types between client devices 104 and system 110 may take place, as will be readily appreciated. In particular, wireless communications of any suitable form (e.g., Bluetooth, near-field communication, etc.) may take place between client device 104 and system 110, such as that which often occurs in the case of mobile phones or other personal and/or mobile devices.

Network-based system 110 may comprise one or more communications servers 120 to provide suitable interfaces that enable communication using various modes of communication and/or via one or more networks 108. Communications servers 120 may include a web server 122, an API server 124, and/or a messaging server 126 to provide interfaces to one or more application servers 130. Application servers 130 of network-based system 110 may be structured, arranged, and/or configured to provide various online services to client devices that communicate with network-based system 110. In various embodiments, client devices 104 may communicate with application servers 130 of network-based system 110 via one or more of a web interface provided by web server 122, a programmatic interface provided by API server 124, and/or a messaging interface provided by messaging server 126. It may be appreciated that web server 122, API server 124, and messaging server 126 may be structured, arranged, and/or configured to communicate with various types of client devices 104, and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, mobile applications, and so forth. API server 124 may be arranged to communicate with various client programs 106 comprising an implementation of API for network-based system 110. Messaging server 126 may be arranged to communicate with various messaging clients and/or applications such as e-mail, IM, SMS, MMS, telephone, VoIP, video messaging, IRC, and so forth, and messaging server 126 may provide a messaging interface to enable access by client 102 to the various services and functions provided by application servers 130.

Application servers 130 of network-based system 110 may be servers that provide various services such as tools for verifying URLs based on information collected about customers. Application servers 130 may include multiple servers and/or components. For example, application servers 130 may include a JavaScript (JS) virtual machine 132, abstraction layer 134, native platform 136, and/or UI rendering engine 138. These servers and/or components, which may be in addition to other servers, may be structured and arranged to provide secured trusted shared rendering.

Application servers 130, in turn, may be coupled to and capable of accessing one or more databases 140 including system call database 142, application database 144, and/or library 146. Databases 140 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

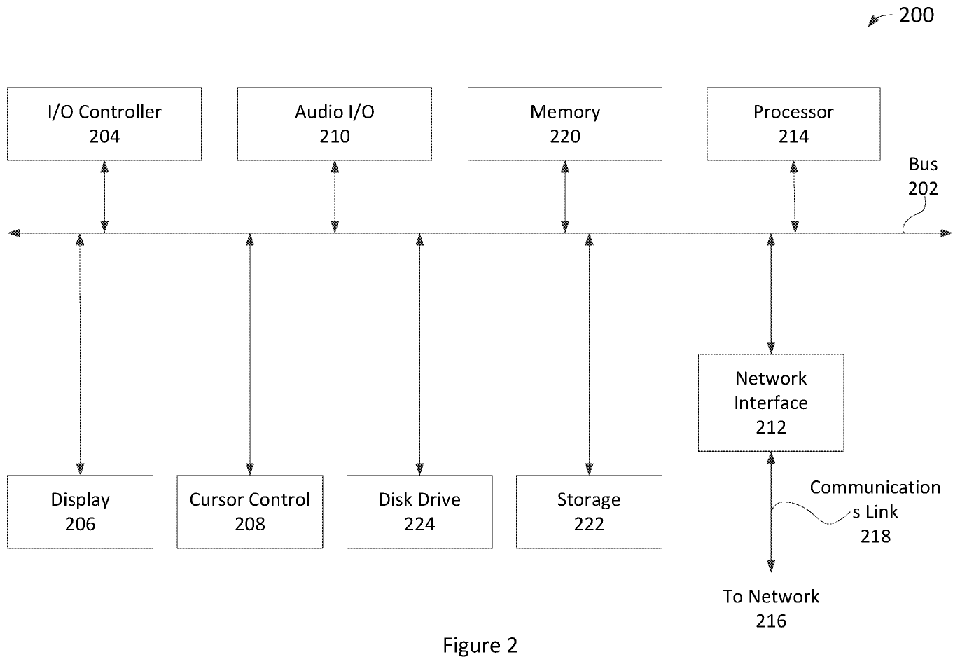

FIG. 2 illustrates an exemplary computer system 200 in block diagram format suitable for implementing on one or more devices of the computing system in FIG. 1. In various implementations, a device that includes computer system 200 may comprise a personal computing device (e.g., a smart or mobile phone, a computing tablet, a personal computer, laptop, wearable device, PDA, etc.) that is capable of communicating with a network. A service provider and/or a content provider may utilize a network computing device (e.g., a network server) capable of communicating with the network. It should be appreciated that each of the devices utilized by users, service providers, and content providers may be implemented as computer system 200 in a manner as follows. Additionally, as more and more devices become communication capable, such as smart devices using wireless communication to report, track, message, relay information and so forth, these devices may be part of computer system 200.

Computer system 200 may include a bus 202 or other communication mechanisms for communicating information data, signals, and information between various components of computer system 200. Components include an input/output (I/O) controller 204 that processes a user action, such as selecting keys from a keypad/keyboard, selecting one or more buttons, links, actuatable elements, etc., and sends a corresponding signal to bus 202. I/O controller 204 may also include an output component, such as a display 206 and a cursor control 208 (such as a keyboard, keypad, mouse, touchscreen, etc.). In some examples, I/O controller 204 may include an image sensor for capturing images and/or video, such as a complementary metal-oxide semiconductor (CMOS) image sensor, and/or the like. An audio I/O component 210 may also be included to allow a user to use voice for inputting information by converting audio signals. Audio I/O component 210 may allow the user to hear audio.

A transceiver or network interface 212 transmits and receives signals between computer system 200 and other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 214, which may be a micro-controller, digital signal processor (DSP), or other processing component, processes these various signals, such as for display on computer system 200 or transmission to other devices over a network 216 via a communication link 218. Again, communication link 218 may be a wireless communication in some embodiments. Processor 214 may also control transmission of information, such as cookies, IP addresses, images, and/or the like to other devices.

Components of computer system 200 also include a system memory 220 (e.g., RAM), a static storage component 222 (e.g., ROM), and/or a disk drive 224. Computer system 200 performs specific operations by processor 214 and other components by executing one or more sequences of instructions contained in system memory 220. Logic may be encoded in a computer-readable medium, which may refer to any medium that participates in providing instructions to processor 214 for execution. Such a medium may take many forms, including but not limited to, non-volatile media, volatile media, and/or transmission media. In various implementations, non-volatile media includes optical or magnetic disks, volatile media includes dynamic memory such as system memory 220, and transmission media includes coaxial cables, copper wire, and fiber optics, including wires that comprise bus 202. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer-readable media. It is also contemplated that software identified herein may be implemented using one or more computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof may be used to implement one or more services, such as the services discussed above and in more detail below.

Traditionally, third-party trusted shared user experiences have been run through iFrames, which is a guest hypertext markup language (HTML) document that's embedded within another host HTML document on a website. Typically, a host provides a portal that serves as a window within which the third-party may expose certain material. In other words, the iFrame HTML element is often used to insert content from another source into a webpage. iFrames are commonly used for advertisements, which are generally less sophisticated and thus, properly suited for iFrame usage. In some cases, more detailed/sophisticated content may also be inserted via an iFrame. This type of content, however, may run into issues

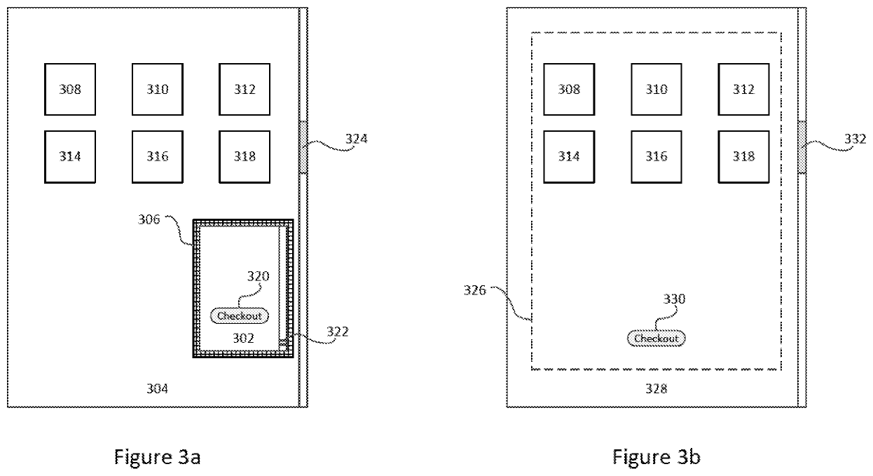

FIG. 3a illustrates an example layout that incorporates guest content 302 on a host webpage 304 using iFrame 306. The host webpage 304, in this example, is a webpage. In some instances, the host webpage may be within a mobile app. For instance, a merchant's website may serve as the host webpage 304. Using Macy's as an example, the webpage, which may show several items for sale 306-316. Additionally, the Macy's website may be integrated with a partner payment processor. A checkout box is provided as the guest content 302 in this example. The checkout box includes a checkout button 320. And because the checkout box is incorporated via iFrames, the checkout box may have its own scroll bar 322 independent of the host webpage scroll bar 324. Scroll bar 322 may be necessary because all the content of the checkout box may not fit within the space allotted by the iFrame 306. For example, within the iFrame 306, the guest content 302 may include a shopping basket with several items. As such there may not be enough space within the iFrame 306 to display all the items. As such, scroll bar 322 is necessitated.

This example exposes one of the shortcomings of iFrame. That is, unless the guest content 302 is tailored to fit neatly within the iFrame 306 provided, the user experience may feel disjointed in that the user is required to navigate within a window inside of another window. Furthermore, it may be unclear to the user whether navigation commands (e.g., alt-back arrow, alt-forward arrow, backspace, etc.) would cause the guest content 302 or the host webpage 304 to respond.

FIG. 3b illustrates an example layout that incorporates a guest content on a host webpage using secured trusted shared rendering. In this example, the guest content 326 is fully integrated into the host webpage 328 such that the checkout experience appears to be native to the host webpage 328. In other words, the user is provided an experience that does not appear to be disjointed like the experience shown in FIG. 3a. For example, the checkout button 330, a single scroll bar 332 that controls the scrolling of the host webpage 328 and the guest content 326 that's been made part of the host webpage 328 provide a native experience using a unified set of navigation controls. The challenge of providing such an experience, however, is that the integration must be performed in such a way so that the host webpage 328 isn't made vulnerable to potential hacking by bad actors by using the guest content 326 as an entry point.

As depicted in FIGS. 3a and 3b, rendering boundaries are a byproduct of the use of iFrames. The proposed solution bridges the gap by serializing the communication between the host and the guest, allowing for a set of defined approved UI elements, and user actions (button clicks, animations) to be shared, while keeping third-party content (i.e., apps) segmented from being able to execute code in the main window (e.g., main application container) or accessing cookie information.

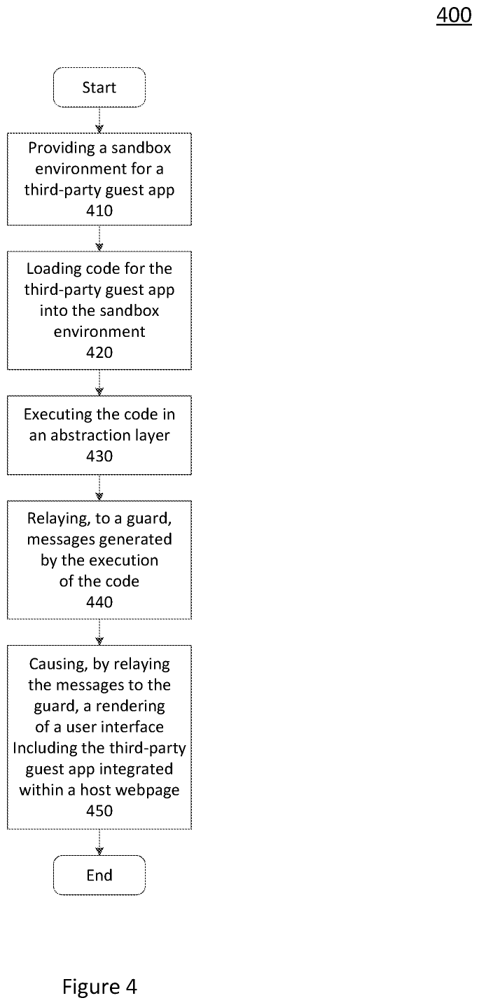

FIG. 4 provides an exemplary process 400 for providing secured trusted shared rendering. In step 410, a sandbox environment is provided for a third-party guest app to be run in an isolated manner. For example, the sandbox may be provided as a JS virtual machine. The sandbox instances may be opened up without having security concerns because the application leverages system level security (e.g., iOS, Android, or web security). Once the sandbox environment is provided, code for the third-party guest app may be loaded into the sandbox for execution in step 420. As shown in the example in FIG. 3b, that third-party code may be a checkout mechanism that the host webpage wishes to incorporate into a website. In some embodiments, multiple third-party applications may be incorporated into the host webpage and run concurrently.

Once loaded, the code may be executed in an abstraction layer in step 430. The abstraction layer maintains all the components necessary for the application to handle eventing. For example, the abstraction layer may include events, UI elements, animations, etc. The abstraction layer provides some amount of flexibility as code can be written in EcmaScript6 (ES6), JS, JSX spec, among others. Since the app is run in a sandbox, messages for events generated by the execution of the code are relayed over the wire to a hypervisor/guard in step 440. Depending on the type of system, the guard will then render the UI and interact with the event system on a host webpage in step 450. In some embodiments, the guard may infer messages back to app sandbox. In other words, the guard may maintain direct communication with the sandbox so that the UI rendering may be dynamic in nature, and may thus be modified to adjust for different rendering scenarios.

The resulting UI is rendered so that instead of having the guest app segmented, the content of the guest app would now be in-line with the host webpage. In other words, all the content would appear to be native to the host webpage. The user may thus interact with the host webpage and not be provided any indication that a third-party guest app even exists on the page. The host webpage may thus benefit for its space no longer being broken by a boundary of a logical container (e.g., as with the use of iFrames) and the webpage will appear to be seamless.

In some embodiments, the guard may be platform specific. The sandbox and abstraction layer, however, may be platform agnostic. In some embodiments, multiple third-party apps may exist in a same sandbox together. These third-party apps are not isolated and can cross-communicate. For example, if two or more third-party apps are corroborating on a single service, those apps may talk to each other within the sandbox.

In order to enhance security, code being executed in the abstraction layer cannot ask to run code that doesn't exist in the native platform structures of the host webpage. Thus if rogue code (e.g., code written by a bad actor) gets infused into abstraction layer, the rogue code will not be able to take over the user's device as that code is still sandboxed. On the other hand, however, cookies may be shared between the host webpage and the third-party guest app. In fact, certain aspects of the host webpage may be selectively exposed to the third-party guest app to enhance the functionality of the app.

The user device (i.e., the computing device) described above may be one of a variety of devices including but not limited to a smartphone, a tablet, a laptop and a pair of augmented reality spectacles. Each of these devices embodies some processing capabilities and an ability to connect to a network (e.g., the internet, a LAN, a WAN, etc.). Each device also includes a display element for displaying a variety of information. The combination of these features (display element, processing capabilities and connectivity) on the mobile communications enables a user to perform a variety of essential and useful functions.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples of the disclosure. A phrase such an “implementation” may refer to one or more implementations and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the terms “include,” “have,” and “the like” are used in the description or the claims, such terms are intended to be inclusive in a manner similar to the term “comprise” as “comprise” is interpreted when employed as a transitional word in a claim.

The word “exemplary” is used herein to mean “serving as an example, instance, or illustration.” Any implementation described herein as “exemplary” is not necessarily to be construed as preferred or advantageous over other implementations.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A system for providing secured trusted shared rendering comprising:
a non-transitory memory storing instructions; and
one or more hardware processors coupled to the non-transitory memory and configured to read the instructions from the non-transitory memory to cause the system to perform operations comprising:
providing a sandbox environment for a third-party guest app;
loading code for the third-party guest app into the sandbox environment;
executing the code in an abstraction layer;
relaying, to a guard, messages generated by the execution of the code;
and causing, by relaying the messages to the guard, a rendering of a user interface that includes a third-party guest app integrated within a host webpage.

2. The system of claim 1, wherein the sandbox environment is a JavaScript virtual machine.

3. The system of claim 1, wherein code for additional third-party guest apps may be loaded into the sandbox environment for execution on the abstraction layer.

4. The system of claim 3, wherein all the third-party guest apps loaded into the sandbox environment can cross-communicate with one another.

5. The system of claim 1, wherein the abstraction layer maintains a plurality of components used for eventing.

6. The system of claim 1, wherein the sandbox environment and the abstraction layer are platform agnostic.

7. The system of claim 1, wherein code executed on the abstraction layer is prevented from running code that does not exist in a native platform structure of the host webpage.

8. A method for providing secured trusted shared rendering comprising:
providing a sandbox environment for a third-party guest app;
loading code for the third-party guest app into the sandbox environment;
executing the code in an abstraction layer;
relaying, to a guard, messages generated by the execution of the code;
and causing, by relaying the messages to the guard, a rendering of a user interface that includes a third-party guest app integrated within a host webpage.

9. The method of claim 8, wherein the sandbox environment is a JavaScript virtual machine.

10. The method of claim 8, wherein code for additional third-party guest apps may be loaded into the sandbox environment for execution on the abstraction layer.

11. The method of claim 10, wherein all the third-party guest apps loaded into the sandbox environment can cross-communicate with one another.

12. The method of claim 8, wherein the abstraction layer maintains a plurality of components used for eventing.

13. The method of claim 8, wherein the sandbox environment and the abstraction layer are platform agnostic.

14. The method of claim 8, wherein code executed on the abstraction layer is prevented from running code that does not exist in a native platform structure of the host webpage.

15. A non-transitory machine-readable medium having stored thereon machine-readable instructions executable to cause performance of operations comprising:
providing a sandbox environment for a third-party guest app;
loading code for the third-party guest app into the sandbox environment;
executing the code in an abstraction layer;
relaying, to a guard, messages generated by the execution of the code;
and causing, by relaying the messages to the guard, a rendering of a user interface that includes a third-party guest app integrated within a host webpage.

16. The non-transitory machine-readable medium of claim 15, wherein the sandbox environment is a JavaScript virtual machine.

17. The non-transitory machine-readable medium of claim 15, wherein code for additional third-party guest apps may be loaded into the sandbox environment for execution on the abstraction layer.

18. The non-transitory machine-readable medium of claim 17, wherein all the third-party guest apps loaded into the sandbox environment can cross-communicate with one another.

19. The non-transitory machine-readable medium of claim 15, wherein the abstraction layer maintains a plurality of components used for eventing.

20. The non-transitory machine-readable medium of claim 15, wherein code executed on the abstraction layer is prevented from running code that does not exist in a native platform structure of the host webpage.
